(19) United States
(12) Patent Application Publication
(10) Pub. No.: US 2015/0248429 A1
(43) Pub. Date: Sep. 3, 2015

(54) GENERATION OF VISUAL REPRESENTATIONS FOR ELECTRONIC CONTENT ITEMS

(71) Applicant: MICROSOFT CORPORATION, Redmond, WA (US)

(72) Inventors: Tiago Pregueiro, Oslo (NO); Dmitry Shaporenkov, Oslo (NO); Lucian Baciu, Oslo (NO); Rune Djurhuus, Oslo (NO); Sverre Tennøe, Oslo (NO); Jørgen Iversen, Oslo (NO); Joshua Stickler, Oslo (NO); Helge Grenager Solheim, Oslo (NO); Zbigniew Tadeusz Manasterski, Oslo (NO)

(73) Assignee: MICROSOFT CORPORATION, Redmond, WA (US)

(21) Appl. No.: 14/194,661

(22) Filed: Feb. 28, 2014

(51) Int. Cl. G06F 17/30; G06T 11/60; G06F 17/21

(52) U.S. Cl. CPC G06F 17/30126; G06F 17/212; G06T 11/60; G06T 2200/24

(57) ABSTRACT

Generation and presentation of visual representations of search results may be provided. In response to any type of search for which one or more content or information items are returned, a preview image is obtained or generated and displayed in a graphical user interface for allowing a user to preview documents or other information items returned for the search query. The displayed preview image may be a selectable object such that selection of the displayed preview image allows the user to navigate to or launch the content item, for example, a searched document, corresponding to the preview image.

### BACKGROUND

Information users and workers gather and process enormous amounts of information for business, education, and pleasure. Typical information users or workers utilize hundreds (or more) of documents, images, electronic communications, data sets and the like. In addition, a typical information user or worker gathers and/or consumes equally large amounts of information through a variety of search mechanisms, for example, file or data search applications, Internet browsing applications, and the like.

When an information user navigates a content item repository (e.g., an electronic file folder), or when the user performs a search on a document or other content file system or content management system, or when he/she performs a browsing function for information gathering of various types, a listing of available content items or search results are returned as a list of items (some selectable) responsive to the user's navigation or search. For example, in response to a navigation of an enterprise file system, the navigating user may be presented with a flat list of file names through which he/she may further navigate for finding a desired file or other content item. Similarly, when the user performs a search, for example, a search of available files in a file system or a browsing search, for example, an Internet search on a given topic, the searching user will receive a flat list of the responsive results. In all these cases, the listed items may include a title and/or uniform resource locator (URL) for search results and possibly a small amount of “teaser” text, quotes or summary information to provide some indication as to the nature of the returned search results. Unfortunately, such returned and presented search results offer little to no resemblance of the actual content items, especially with respect to content fonts, colors, formatting, etc. For textual content items, a small snippet of text seldom conveys more than the most basic understanding of the underlining content items, and for highly structured documents, such as spreadsheets and slide presentations, the search results provided in the list give almost no insight into the relevance of the search result to the searching user.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing generation of visual representations of navigated content items or content items responsive to a search. In response to any type of content repository navigation or search for which one or more content or information items are returned, a preview image may be generated and displayed in a graphical user interface for allowing a user to preview documents or other information items returned for the navigation or search query. For example, in response to a navigation or search on a file system that returns a list of documents of various types, a preview image for each document in the list may be displayed to allow the user to visually appreciate the nature of each returned document.

If a preview image is not available for a given item, a preview may be dynamically generated. To generate a preview image for a searched item, media content (e.g., images, charts, tables, headings, etc.) contained in the searched item are identified as preview candidates. The preview candidates are then ranked according to a number of ranking variables, and a highest ranked candidate is chosen as a preview image for the searched item. For example, if the searched item is a spreadsheet document, a colorful chart in the document may be selected as a preview image that may then be displayed as a search result corresponding to the searched spreadsheet document.

The user may then review the displayed preview image for a quick visualization of the returned content item for assisting the user in determining whether the returned content item is desired. According to an embodiment, the displayed preview image may be a selectable object, such that selection of the displayed preview image allows the user to navigate to or launch the content item, for example, a searched document, corresponding to the preview image.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings which are incorporated in and constitute a part of this disclosure, illustrate various embodiments of the present invention.

FIG. 1 is a block diagram illustrating a system for generating and displaying a preview image as a visual representation of a returned content item.

FIG. 2 is illustrates a graphical user interface in which is displayed one or more preview images as visual representations of returned content items.

FIG. 3 is a flow diagram illustrating a method for providing a preview image as a visual representation of a returned content item.

FIG. 4 is a flow diagram illustrating a method for generating a preview image as a visual representation of a returned content item.

FIG. 5 is a block diagram illustrating example physical components of a computing device with which embodiments of the invention may be practiced.

FIGS. 6A and 6B are simplified block diagrams illustrating components of a mobile computing device with which embodiments of the invention may be practiced.

FIG. 7 is a simplified block diagram of a distributed computing system in which embodiments of the invention may be practiced.

### DETAILED DESCRIPTION

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

As briefly described above, in response to loading documents from a content repository or in response to returning one or more search results, for example, an enterprise file storage repository, a shared resources server, a mailbox server, and the like, or in response to a browsing, explicit or implicit search operation, for example, an Internet search, preview images may be presented in a graphical user interface as visual representations of returned search items. When one or more search results are returned components of the underlying results content items, for example, the title of a document, a uniform resource locator (URL) for a search result, a text snippet from a main body of text of a returned item, and the like, are designated as preview image candidates. Each candidate is ranked based on one or more ranking variables. The best one or more images from the list of preview candidates based on the rankings may be designated (and combined if more than one image for a given search result) as a preview image for a returned search result and may be stored for subsequent search queries or requests that return the same search result, for example, the same document, or other content item.

In addition, a predominant color that may be associated with a returned content item or search result, for example, background coloring contained in a document may be obtained and applied to a generated preview image. In addition, metadata about the generated preview image may be stored so that subsequent navigations or searches that return the same content item or search result may readily find the generated preview image.

According to one embodiment, when preview images are required for one or more content items, a preview image service (described below) acts in a two phased manner where first the service determines which content items to present as preview images, and second the service generates images for content items for which preview images are not already available. Before preview images are rendered, the preview image service may gather metadata about the images, such as width, height and predominant color of each preview image. Then, before the preview images (either previously generated or newly generated), are rendered, the service begins rendering the display screen with space set aside for the images. The service may then render the images in the set aside spaces which may reduce re-scaling or other awkward presentation issues as the images are displayed. According to one embodiment the service may display the images as they are returned with one or more animations to provide a pleasing rendering presentation. The user may select the displayed preview images for navigating to or launching the documents or other content items corresponding to the displayed preview images.

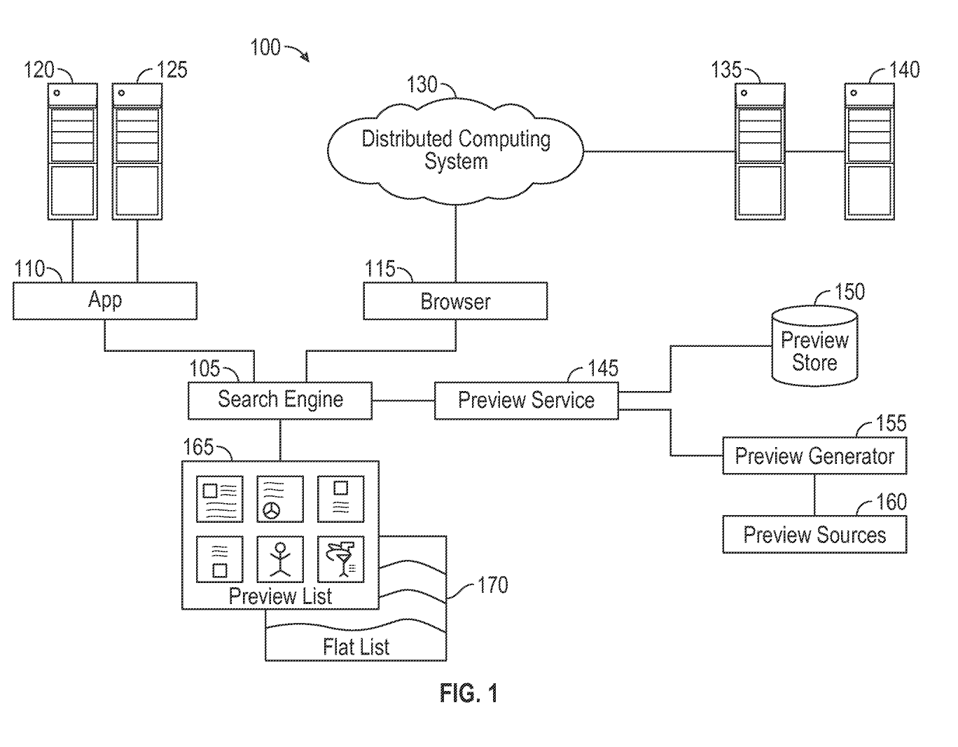

FIG. 1 is a block diagram illustrating a system for generating and displaying a preview image as a visual representation of a returned content item or search result. The search engine 105 is illustrative of a search mechanism that may perform a search for one or more content items through an application 110 or through a browser 115. For example, the search engine 105 may operate as a search functionality of an application 110, for example, a word processing application, a spreadsheet application, a slide presentation application, notes application, and the like. For example, the search engine 105 may operate as a search module or function of any of such applications for searching local or remote memory storage areas for files of various types, including documents or other content items. For example, a given enterprise, for example, a company, educational facility, or the like, may operate file and other content storage systems on one or more enterprise servers 120, 125, and information users/workers may search for files, including documents, images, electronic communications, and the like stored at the enterprise servers 120, 125 via any application 110 capable of searching for such content.

In addition to the aforementioned software application types, the application 110 may represent a document management system operated by an enterprise to allow its employees, members or other associates to search for documents and other content items maintained by the enterprise. As illustrated in FIG. 1, the search engine and application 110 may also search for content items stored at remote servers 135, 140 via a distributed computing system 130, such as the Internet or an intranet. For example, a given enterprise may store its files, documents, and other content items at a remote (sometimes referred to as cloud-based) storage system that may include one or more servers 135, 140.

Referring back to the search engine 105, the search engine 105 may also be associated with a browser application 115 for allowing users to search for various information items via the distributed computing network. For example, the search engine 105 operating via the browser 115 may allow users to search for various content items through enormous numbers of web-based information sites. Thus, as should appreciated, the search engine 105, the application 110 and the browser application 115 are illustrative of software applications or modules having sufficient computer executable instructions for allowing searches of various local and remote memory storage repositories for any type of available information, including documents, images, electronic communications, web-based information, and the like.

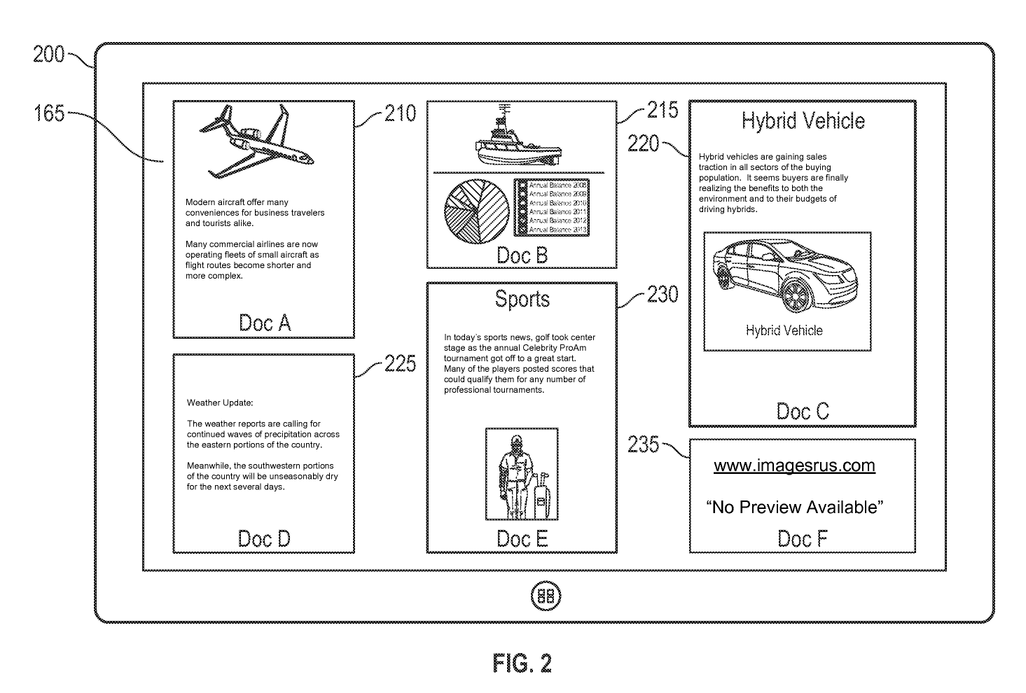

Referring still to FIG. 1, a preview service 145 is a software application having sufficient computer executable instructions for preforming the generation and display of preview images for returned content items or search results, as described herein. Operation of the preview service 145 is described in further detail below with respect to FIGS. 2-7. The preview store 150 is illustrative of a memory storage medium at which preview images may be stored for subsequent presentation to a user as visualizations of content items or search results. The preview store 150 may be stored at a local computing device operated by an individual user, or may be stored at an enterprise level storage medium, for example, the servers 120, 125, or the preview store 150 may be stored remotely from a searching user at a cloud-based system 135, 140.

The preview generator 155 is a software application or module containing sufficient computer executable instructions for generating a preview image for presentation to a user as a visualization of one or more content items or search results, as described below. Preview sources 160 are illustrative of various sources for obtaining preview images or portions or components of preview images, as will be described below. For example, a preview source 160 may include a word processing application operative to provide components of a word processing document that may be utilized for generation of a preview image. Similarly, a preview source may include a spreadsheet application operative for providing information from a spreadsheet document including components of the document that may be used for generation of a preview image, and the like. A preview source 160 may also include an application or service that may be called by the preview generator 155 for generating a preview image, such as a screenshot or thumbnail image of a document or other content item.

Referring still to FIG. 1, a graphical user interface 165 is illustrated in which is displayed one or more preview images for one or more content items or search results that have been provided to a user in response to a local or remote information search. As will be described in detail below, in response to a given search, for example, a search on a local or remote file folder for one or more documents, instead of providing a list of document identifiers in a list 170, a preview image may be obtained or generated for each returned content item or search result item and may be displayed in the user interface 165 to allow the user a quick visualization of the nature of each returned result and to allow the user to selectively navigate to or launch each returned result, if desired. The list 170 is illustrative of a typical listing of content items or search results. For example, according to prior systems, if a user searches for a given document in a file folder of documents, or if the user searches for information via a web-based information repository, or any other search, as described above, a flat list 170 may be returned that simply lists, possibly in some type of ranked order, each document, website, or other information item that is returned by the search engine 105 for consideration by the user.

FIG. 2 illustrates a graphical user interface in which is displayed one or more preview images as visual representations of returned content items or search results items. As described above, when a user performs a search for which the user may ordinarily receive a flat list of identified content items or search results, for example, documents, images, files, electronic communications, web-based information, and the like, the user may receive a preview image for each returned content item or search result that allows the user a quick visualization of the nature of each returned content item or search result. As illustrated in FIG. 2, a number of preview images 210, 215, 220, 225, 230, 235 are illustrated as displayed in a user interface 165 on a tablet-style computer device 200. As should be appreciated, the user interface 165 may be provided by any of a variety of software applications capable of searching and returning content items or search results as described above with reference to FIG. 1. In addition, it should be appreciated that the tablet-style computing device 200 is for purposes of illustration and example only and is not limiting of different types of computing devices with which the user interface 165 may be presented, including desktop computers, laptop computers, handheld devices, such as smartphones, and the like. As will be described below, in response to a search for which one or more content items or search results are returned, a preview image may be obtained from a preview store of previously generated preview images, or the preview image may be generated for each of the returned content items or search results. The preview service may take user information, query text and/or context into account when generating the preview images, for example, for the same document a software developer may see a different image than a business analyst, while if the query matches a figure or other object caption, that figure or object might be selected as the candidate preview image for that document. Also if a request is made from a device with larger resolution, a larger resolution image may be returned, while if the request comes from a device with a small resolution display, a smaller image may be sufficient. According to embodiments, a generated preview image may include one or more components extracted from an underlying content item returned for a given search. For example, the preview image may include an image that was added to the underlying content item by a user. The preview image may be composed of a number of images or a collection of images that were added to the underlying content item by a user. The preview image may include a screenshot of an arbitrary page, slide, sheet, or other section of an underlying content item, or the image may be composed of or include a number of screenshots of such components of the underlying content item. A preview image may include a background color and a snippet of extracted text that provides a user readable text and coloring to indicate certain aspects or natures of the underlying content item. A preview image may include a chart, table, pivot table, or other object of an underlying content item, for example, a spreadsheet application document, a slide presentation application document, and the like. A preview image may include a diagram, smart art, shapes, and the like included in an underlying content item.

In addition, a preview image may include a tag cloud with the most used words in a document or other content item, giving a visual representation of what the document or content item is about, with the most used words presented with larger fonts. A preview image may be an image selected from a predefined set of “clip-art” images or thematic images. For example, if the content item contains a lot of text about “performance” or “metrics”, an image of a known high-performance car might be used as a visual representation, while content item about “sorting” might receive an image with some cards on a table sorted in ascending order. A preview image could be generated that represents any other metadata of the content item, such as a picture of the author, an image representing the file type, a “bar” representing the size of the document (small, medium, large), or some symbolic image representing the last modified date (old documents could get a picture of an old person, new documents could be pictured as a baby etc.).

Other example images may include a preview image as a cropped version of an image that lives in the document. A preview image may be a collage of several objects within the document, for example, images, pieces of text, etc. A preview image may be a collage of screenshots of N pages, slides, or sheets of the corresponding document or content item. A preview image may include a pull quote of the most interesting paragraph or sentence in the document or content item. A preview image may be a tag cloud of the most used numbers in a spreadsheet. A preview may include an image obtained from an external source (e.g., via an Internet browsing application) that represents the most frequent terms in the document (e.g. a picture of a plane obtained from the Internet for a document that does not contain any images). A preview image may include an auto-generated table, chart, or other visual representation of the data contained in the document. As should be appreciated, the foregoing examples of preview images that may be used or generated according to embodiments of the invention are for purposes of illustration and are not exhaustive of other images that may be utilized or generated for a given content item or search result.

Thus, as should be appreciated, a preview image generated and displayed according to embodiments of the present invention may include any component or formatting property applied to an underlying content item which when included in a preview image for a given returned search item provides a user with a quick and easily understandable visualization of the underlying content item so that the user is not required to select the underlying content item from a list of content items to visualize information that may be provided by the underlying content item.

Referring still to FIG. 2, a number of example preview images are illustrated. The image 210 includes an example image of an aircraft that was added to an underlying document along with a snippet of text. The resulting preview image 210 allows a user to view the example aircraft image and quickly read the snippet of text to allow the user to very quickly understand the nature of the document or other content that corresponds to this preview image. As described above, a preview image may be composed of many images added by the user, or an image may include a chart, table or pivot table from a document, such as a spreadsheet file. Referring to the image 215, the preview image has been generated to include an example image of a boat followed by images of a chart and a table. As should be appreciated, such images may be associated with any of a variety of documents, for example, a spreadsheet file. By providing the preview image having the charts, tables, and other associated objects, the user may receive a very quick visualization of the nature of the underlying document. According to one embodiment, a preview image may include a background color that is representative of various elements of the underlying content item over which a snippet of text or information may be imposed to provide the user not only information from the provided text snippet or other information, but to give the user a sense of the look and feel of the underlying returned search item, or to help the user with recognizing the best/most relevant result matching an explicit query, or entice the user to read something new, or help the user in recognizing his/her own content or something the user has seen before.

The images 220, 230 may be illustrative of information obtained from a webpage via a browsing function or, for example, a headline such as “Sports” or “Hybrid Vehicle” may be provided in the image followed by a text snippet, followed by a photograph or other image, such that the resulting preview image 220, 230 provides a visualization of the information available in the underlying content item returned as a content item or search result. According to other embodiments, if such highly identifiable elements as charts, images, photographs, unique coloring, and the like, are not available for an underlying content item, a screenshot of an arbitrary page, slide, sheet of a document or a combination of screenshots of pages, slides, sheets may be provided, as illustrated for the preview image 225.

As will be described below, in some cases, a preview image may not be obtained or generated for a given content item or search result, for example where the underlying content item may not be accessed by the preview service 145. In such a case, an identification of the returned result and an indication that a preview image is not available may be provided as a preview image, as illustrated for preview image 235 in FIG. 2. As should be appreciated, the preview images illustrated in FIG. 2 are for example an illustration only and are not limiting of the vast numbers of different combinations of elements that may be assembled in a given preview image for providing a searching user a visualization of a content item returned in response to an information search.

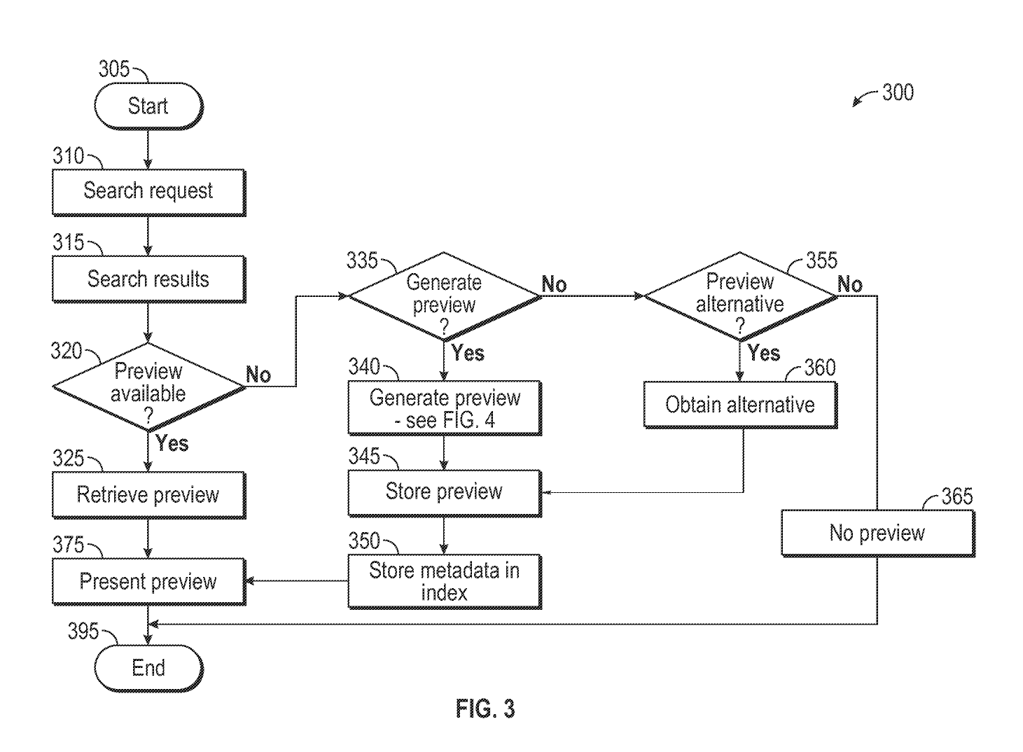

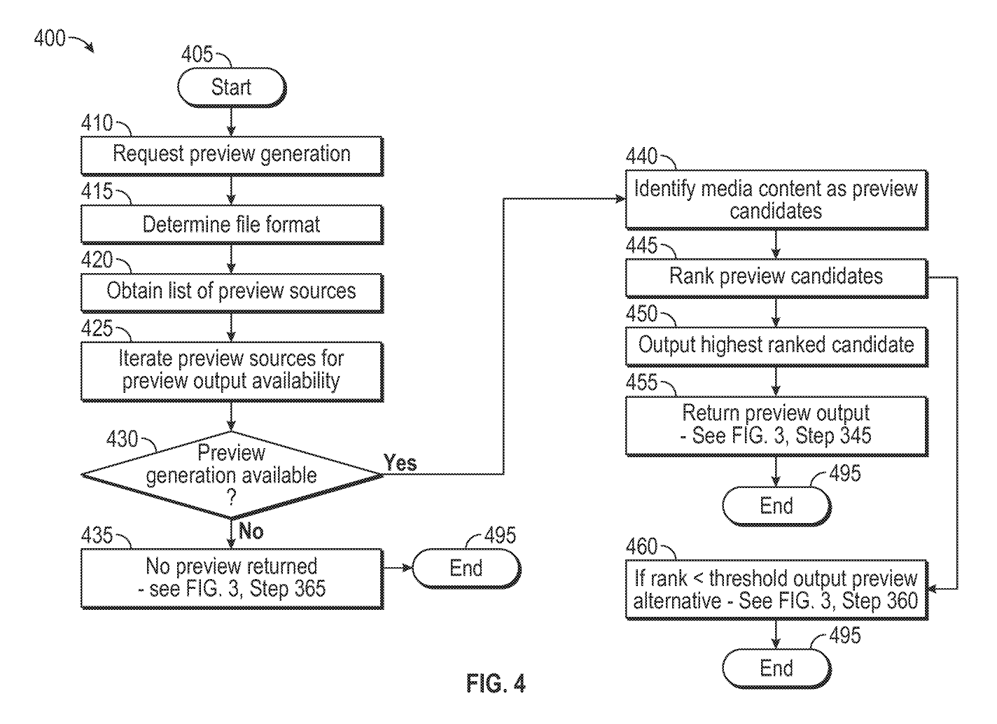

FIG. 3 is a flow diagram illustrating a method for providing a preview image as a visual representation of a returned search item. According to embodiments, when a user conducts a search on a local or remote information repository, or when a user conducts a browsing action for information available via various Internet-based sources, the preview service 145 may be called by the application 110, 115 in use for the searching operation for obtaining or generating preview images for each returned content item or search result. The routine 300 illustrated in FIG. 3 begins at start operation 305 and proceeds to operation 310 where a search request is initiated by a user. For example, the search request may be directed to documents or other content items maintained at a file or document repository or management system, or the search may be directed to an Internet-based collection of information items that be of interest to the user. At operation 315, content items or search results are returned to the applications 110, 115 and are passed to the preview service 145 for provision of preview images for each returned content item or search result, as illustrated above with reference to FIG. 2.

As should be appreciated, the operations described herein may be iteratively performed for each content item or search result, or the operations may be performed in parallel for each returned content item or search result. At operation 320, the preview service 145 queries the preview store 150 to determine whether a preview image is already available for one or more of the returned content items or search results. For example, during a prior search by the same user or by any other user, exactly the same document file or other content item (e.g., same URL), may have been returned and a preview image may have already been generated for returned content item or search result and may have been stored at the preview store 150. As will be described below, when a preview image is generated, metadata for the preview image is stored in a searchable index to allow the preview service 145 to search the preview store to determine whether a preview image for a given content item already exists. If a preview image is available for a given content item or search result, the routine 300 proceeds to operation 325, and the preview service 145 retrieves the available preview image from the preview store 150. At operation 375, the retrieved preview image is presented to the user in a user interface 165, as illustrated in FIG. 2.

Referring back to operation 320, if the preview service determines that a preview image is not available for a given content item returned as a content item or search result, the routine proceeds to operation 335, and a determination is made as to whether a preview image may be generated for each returned result. If a preview may be generated for a given return result, the routine 300 proceeds to operation 340, and a preview image is generated for a given returned result, as will be described in detail below with respect to FIG. 4. At operation 345, the generated preview image is stored at the preview store 150.

At operation 350, metadata for the generated and stored preview image is stored in an index at the preview store 150 for allowing the preview service 145 to locate the generated and stored preview image in response to a subsequent search that returns exactly the same content item for which the preview image has been generated. According to embodiments, storing metadata for a preview image that has been generated allows for a smoother user experience with the user interface 165, illustrated in FIG. 2. For example, when the preview service 145 finds a previously generated preview image for a given search item, the application may start by requesting metadata for the preview image (e.g., from a search index or other storage 150), and thus, the preview service 145 may immediately render a placeholder in the user interface 165 based on the metadata (e.g., height, width, predominant color, etc.) available for the associated preview image. The preview service 145 may then initiate a second request to the preview store 150 to request data for the preview image. By reserving a space and having a predominant color as the background in that allocated space, when the image is actually returned from the preview store 150, a smoother transition may happen without disrupting the user interface layout. After the generated and stored preview image is returned, it may be presented to the user in a user interface 165, as illustrated in FIG. 2.

Returning back to operation 335, as should be appreciated, the processing described herein is for each result returned for a given search. If it is determined that a preview image for a given returned content item or search result may not be generated, as will be described below with reference to FIG. 4, the routine proceeds to operation 335 and a determination is made as to whether a preview image alternative may be provided, for example, a simple screenshot of a given page of a returned search item may be provided as a preview image alternative. If such a preview image alternative may be provided, the routine proceeds to operation 360 where the alternative preview image may be generated. At operation 345, the alternative preview image may be stored for subsequent recall, and at operation 350, metadata for the alternative preview image may be stored, as described above. The alternative preview image may then be presented to the user at operation 375, as illustrated above with reference to FIG. 2.

Referring back to operation 335, if it is determined that no preview image may be generated, as described further below with reference to FIG. 4, then the routine ends at operation 395, and no preview image will be displayed to the user as illustrated in FIG. 2. As should be appreciated, in such cases where no preview image may be provided, a simple identifying text string may nonetheless be presented in the user interface 165 for presenting information associated with the corresponding returned content item or search result to allow the user to select the returned content item or search result, as illustrated as image 235 in FIG. 2.

FIG. 4 is a flow diagram illustrating a method for generating a preview image as a visual representation of a returned search item. As described above with reference to FIG. 3, if it is determined that a preview image is not available and that a preview image may be generated for a given content item or search result content item, the preview service 145 calls on the preview generator application 155 for generating a preview image for each content item for which a preview image is required. In general, the preview generator 155 determines a content type for each content item for which a preview image is to be generated, and then determines the availability of components of the content item, for example, images, charts, text snippets, headings, and the like that may be extracted from the content item for inclusion in a preview image. In addition, the preview generator 155 may consider the availability of other sources of information that may assist in the generation of a preview image if needed.

Referring to the routine 400 illustrated in FIG. 4, if a preview image is to be generated for a returned search item, the routine 400 begins at start operation 405 and proceeds to operation 410 where the request for preview generation is received by the preview generator application 155. As should be appreciated, the process described below with respect to the flowchart illustrated in FIG. 4 is performed for each content item returned in response to a user's search request for which a preview image is required.

At operation 415, the preview generator 155 reviews the first content item for which a preview image is to be generated and determines a file format associated with the content item. As should be appreciated, knowing a file format associated with the content item may assist the preview generator in finding and extracting components of the content item with which a preview image may be generated. For example, the preview generator may first determine the type of content item that has been returned. That is, knowing whether the content item a word processing document, a spreadsheet document, a slide presentation document, a notes document, a text only document, a photograph, a collection of images, a web page, and/or the like will assist in the process of generating a preview image.

In addition, the preview generator may also determine document structuring applied to the returned content item to assist the preview generator in finding information in the returned content item and for extracting found information if needed for preview image generation. For example, if the returned content item is structured according to the Hypertext Markup Language (HTML), then the preview generator 155 may utilize an understanding of HTML to find tagged portions of the returned content item for locating headings, text snippets, images, and the like contained in the returned content item. For another example, if the document is structured according to a markup language, such as the Extensible Markup Language (XML), then the preview generator 155 may obtain an underlying XML schema file associated with the returned content item for learning the nature of tagged elements of the returned content item that may be used for finding and extracting components of the returned content item for preview image generation, as described herein. As should be appreciated, these are but a few examples of document structuring and formatting that may be utilized for finding elements or components of a returned search item that may be used in generating a preview image.

At operation 420, the preview generator 155 may obtain a prioritized list of available sources for the file format determined for the content item for which a preview image is being generated. For example, if the returned content item is an HTML-formatted document retrieved from an Internet-based website, a first source for finding and extracting information from the returned content item may include an HTML parsing application capable of parsing an HTML document and for locating components such as photographs, images, text headers, and the like that may be used for inclusion in a preview image. A secondary source for the received HTML-formatted content item may be a word processing application capable of finding information in text portions contained in the HTML-formatted content item for returning information that may be used in a preview image. For example, if the user's original search query included a text string, and the text string is found in a tagged portion within an HTML-formatted content item, a secondary source in the form of a word processing document may be a best source for locating a matching text snippet in the returned content item for use in generating a preview image. For another example, if the user's original search query included a text string, the text string may be used to find and return an image in proximity of the text string, for example, an image having the located text string in a caption under or near the image.

For another example, if a returned content item is a spreadsheet document, then a first source for outputting information for preview image generation may be a spreadsheet application. Similarly, if a returned content item is a slide presentation document, then a first source for outputting content from the slide presentation document for preview image generation may be a slide presentation application, and so on. In addition, a source may include a software application or service to which the content item may be passed for generating a simple screenshot or thumbnail representation (e.g., a bitmap image) of a given page of the returned content item with which the preview image may be generated. As should be appreciated, these example sources are for purposes of illustration only and are not limiting of different sources with which information may be found, extracted, copied, or otherwise utilized for generating a preview image, as described herein.

At operation 425, the various preview sources 160 identified by the preview generator 155 for obtaining preview image output may be iterated for determining a best source for use in generating the preview image, as described herein.

At operation 430, a determination is made as to whether preview generation is available. If it is determined by the preview generator 155 that a preview image may not be generated for a given returned content item or search result, then the routine 400 proceeds to operation 435 and no preview is returned, as described above with reference to FIG. 3, operation 365. For example, if an Internet-based search returns a number of content items or search results in response to a given search query, a given content item or search result may include a URL that is for some reason not immediately accessible by the preview generator 155 for generating a preview image. For example, the URL may be associated with content that is secured from access requiring various authentication steps by an accessing user for actually accessing and opening a content item associated with the URL. In such a case, the preview generator 155 may not obtain information associated with the returned URL from which a preview image may be generated. This is but one example of a situation in which the preview generator 155 may not review content associated with a returned search item with which a preview image may be generated.

In such a case, as described above with reference to FIG. 3, some alternative preview image may be provided for the sake of continuity and usability by the user. For example, if a returned URL may not be accessed by the preview generator, resulting in an inability to generate a preview image, a text box or similar object may be presented in the user interface 165, as illustrated in FIG. 2, in which the URL or other content identifier for which no preview image may be generated is displayed so that the user may at least see that the URL or other content item was returned in response to his/her search query, but the user will see that no preview image is available. As should be appreciated, a text string such as “no preview image available” may be provided in association with a content item identification. Such a displayed content item identification and text string is illustrated as preview image 235 in FIG. 2.

Referring back to operation 430, if it is determined that a preview image may be generated for a returned search item, the routine proceeds to operation 440, and media content contained in the returned search item may be identified as preview candidates. For example, referring back to the example of a returned HTML-formatted content item, at operation 440 the returned content item may be parsed according to the HTML formatting for the content item for identifying text headings, text summaries, photographs, images, charts, coloring, or any other identifiable aspect of the returned content item that may be extracted and that may be used for assisting the preview generator 155 in generating a preview image for the content item.

For another example, if the returned content item is a word processing document containing a number of images, for example, photographs, charts, tables, text selections, and the like, then at operation 440, each component of the word processing document may be identified for use in generating a preview image for the example word processing document. Likewise, if the returned content item is a spreadsheet document or slide presentation document components of the documents may be identified, including charts, tables, images, text headings, titles, and the like that may be used for generating preview images for the example documents, as described herein.

According to embodiments, each media content item, for example, images, photographs, charts, tables, text selections, etc. identified in a returned content item are designated by the preview generator 155 as preview image candidates. That is, as a preview image candidate, each of the media content items or components of a given content item may be used as a preview image or as a component of a preview image. For example, if a document returned as a search item includes multiple photographs, charts, images, text selections, and the like, each of such components may serve as the preview image, or combinations of such components may be combined together to generate a preview image, for example, the preview image 215 illustrated in FIG. 2.

At operation 445, each of the preview candidates identified by the preview generator 155 may be ranked according to one or more ranking variables. Such ranking variables may include, but are not limited to a determination of a resolution of an image that has been identified as a preview candidate (e.g., a product of the height versus the width of the candidate image). Another ranking variable may include a position of the candidate image or other component in the returned search item. For example, if a candidate image is on the very first page of a returned content item, for example, a photograph or other image on a title page of a document, the image may receive a higher ranking than an image positioned at the end of a document or other content item or deeply embedded in the document or content item. That is, an image that is at or near the front of a received content item may be more illustrative of the nature of the content item and therefore a better candidate for placing in a preview image for the content item. A next ranking variable may include a ratio of height versus width for any image candidate. For example, if an image candidate is extremely narrow in terms of height versus the width, such a candidate may not provide a suitable look and feel when placed in a preview image, as illustrated in FIG. 2. Another ranking variable may describe and utilize the uniqueness of the image, for example, in order to filter out watermark images or images in headers or footer sections that are repeated across many documents and therefore are less interesting as potential preview images.

Another ranking variable that may be used may include the colorfulness of a preview candidate image (e.g. percentage of non-white, gray or black pixels comprising the candidate image). As described above, a preview image may be generated using predominant coloring found in the corresponding search item. According to one embodiment, a method used to decide what is the predominant color of a given preview image candidate includes first reducing the number of colors in the image (e.g. reduce color depth) by merging similar colors, followed by counting the color with the most pixels in the preview image candidate. Alternatively, a center-weighted method may be used when counting pixels of various colors similar to methods used by cameras when measuring light intensity. Another ranking variable may be related to more advanced image analysis techniques, such as the number of people or objects recognized in the image, where an analysis may be performed as to who the people are or what the objects are and as to what is the perceived importance of the people or objects to the contents or nature of the document or content item.

As should be appreciated, each of these example ranking variables are for purposes of illustration and example only and are not limiting of other ranking variables that may be utilized. For example, combinations of such ranking variables may be applied where a given image is ranked on both its location in a content item, its colorfulness and its resolution. That is, a given candidate that ranks highly in a multiple of ranking variables may be ranked higher for inclusion in a preview image than a content item that ranks highly according to one variable but significantly less according to other variables. In addition, metadata associated with a given candidate may similarly be used for assisting in the ranking process. For example, if it is determined that an image contained in a received content item is closely associated with an important aspect of the content item, for example, where the image is a photograph of the author of the content item, such information may be used for ranking the image candidate.

For each ranking variable, a weighting may be provided so that a given ranking variable may be weighted more than other ranking variables in determining whether a given preview image candidate may be included in a generated preview image. For example, the resolution of a preview image candidate may be ranked higher than a position of the preview image candidate in a given content item because if the resolution of the preview image candidate is such that the candidate will generate a poor visualization in the generated preview image, then a higher weighting on resolution will assist in ultimately determining appropriate components of the generated preview image.

According to an alternative embodiment, choosing which preview image candidate to use in the generated preview image includes analyzing (e.g. ranking) all preview image candidates in parallel. According to this embodiment, for each preview candidate, a quality score may be generated by the preview generator (e.g., a score between zero and one). The preview generator 155 may be pre-configured with a quality score for each preview image candidate, and the score for each preview image candidate may be calculated as follows: document preview score =score for individual preview image component x total scores for preview image components that may be applied to a generated preview image.

The scores for a preview image candidate or component are typically parameterized by file type such that one preview image candidate or component has a higher score for one application type, for example, a spreadsheet application, and a lower score for another application type, for example, word processing application. In this manner, high quality images from the best application type will be preferred over high quality images from a lesser application type. For example, a chart image based on data from a spreadsheet application may receive a higher score than the chart image would receive form a word processing application that may not be as well equipped to output a chart object as the spreadsheet application. According to this embodiment, the preview generator 155 may request such images from the available sources in a hierarchical manner. For example, if the image is a chart image as described above, the preview generator may first query a spreadsheet application, followed by a word processing application, followed by a slide presentation application, and so on, where the best source is queried first, followed by a lesser source, and so on.

At operation 450, the preview generator outputs the highest ranked candidate as either the preview image that will be displayed in the user interface 165, or the preview generator outputs the highest ranked candidate as a component that will be used in the preview image. After all preview candidates for a given content item or search result are outputted, the preview generator may generate the preview image that will be presented to the user as illustrated in FIG. 2. According to one embodiment, the preview generator may utilize a structured preview image object, for example, a template for containing various outputted preview candidates. That is, a template may allow for an image in one portion of the preview image and for text or other information in another portion of the preview image. For example, if the preview generator 155 generates an image such as the image 210, illustrated in FIG. 2, the preview generator may be programmed to structure the image such as the example aircraft image at a top portion of the generated preview image and an appropriate text snippet or summary beneath the displayed image. Alternatively, other orientations of text versus images may be utilized, for example, the sports headline and photograph preview image 230 illustrated in FIG. 2. That is, as should be appreciated, any orientation of images, text snippets, or other information components may be utilized by the preview generator 155 for generating and displaying a preview image, as illustrated in FIG. 2. Alternatively, and as may be the case in many instances, a given image returned as an outputted candidate will be the preview image that will be displayed in the user interface 165.

According to one embodiment, the preview generator may ensure that all preview images are generated according to a specified size so that a size of the preview image does not indicate a ranking of a given content item versus other content items. Alternatively, the preview generator may generate a preview image according to different sizes to accommodate varying amounts or types of information, images or other content that may be placed in a generated preview image. As should be appreciated, when the preview images are presented to the user in the user interface 165, they may be ordered according to an ordering of the returned content items or search results or any other ordering as desired. At operation 455, the returned preview image output is stored in the preview store 150, as described above with reference to FIG. 3, step 345.

Referring back to operation 445, in some cases, a ranking applied to one or more preview candidates results in a ranking that is beneath a threshold ranking value such that it may be determined that a preview image generated from the ranked one or more image candidates will be unsuitable for use as a preview image. At operation 460, if the ranking applied to one or more preview images is beneath a threshold output, a preview alternative may be generated for the received search candidate. For example, if a returned content item contains one or more images, but the image quality in terms of various ranking variables such as resolution, colorfulness, position, ratio of height versus width, etc. is very poor, it may be determined that the ranking for the candidate is too low to be presented to the user as a preview image. In such a case, an alternative preview image source, for example, an application or service that may take a simple screenshot of page or object in the returned content item, or that may generate a thumbnail image of the returned content item, or the like may be utilized for generating a preview image that may be stored and presented to the user in a user interface 165, as illustrated in FIG. 2. According to one embodiment, different ranking models or different combinations of ranking variables may be used for different client applications or end-user requirements. That is, where one client application, for example, a word processing application may be better suited for images having a mix of text and images, another application, for example, a spreadsheet application may be better suited for images having charts or tables. Similarly, an end-user that is data oriented may prefer variables that favor spreadsheet types of images, while an end-user that is more artistic, for example, a graphics design enterprise, may prefer ranking variables likely to produce more artistic looking images.

After all preview images are generated and returned, or after any preview images are rejected for preview generation and/or are passed to a secondary source for generation of an alternate preview image, the routine 400 ends at operation 495.

Referring back to FIG. 3, and as described above, after a preview image is generated for a given returned search content item, metadata for the preview image is stored so that subsequent searches that return exactly the same content item or search result as a content item or search result for which a preview image has previously been generated may cause the previously generated preview image to be obtained and presented to the user in a user interface 165, as illustrated and described above with reference to FIG. 2. Thus, in response to any type of search conducted by a user for which one or more content items are returned, the user may receive a pleasing visual representation for each search item, if available, which will allow the user to quickly understand the nature of each of the items returned in response to his/her searching activity.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

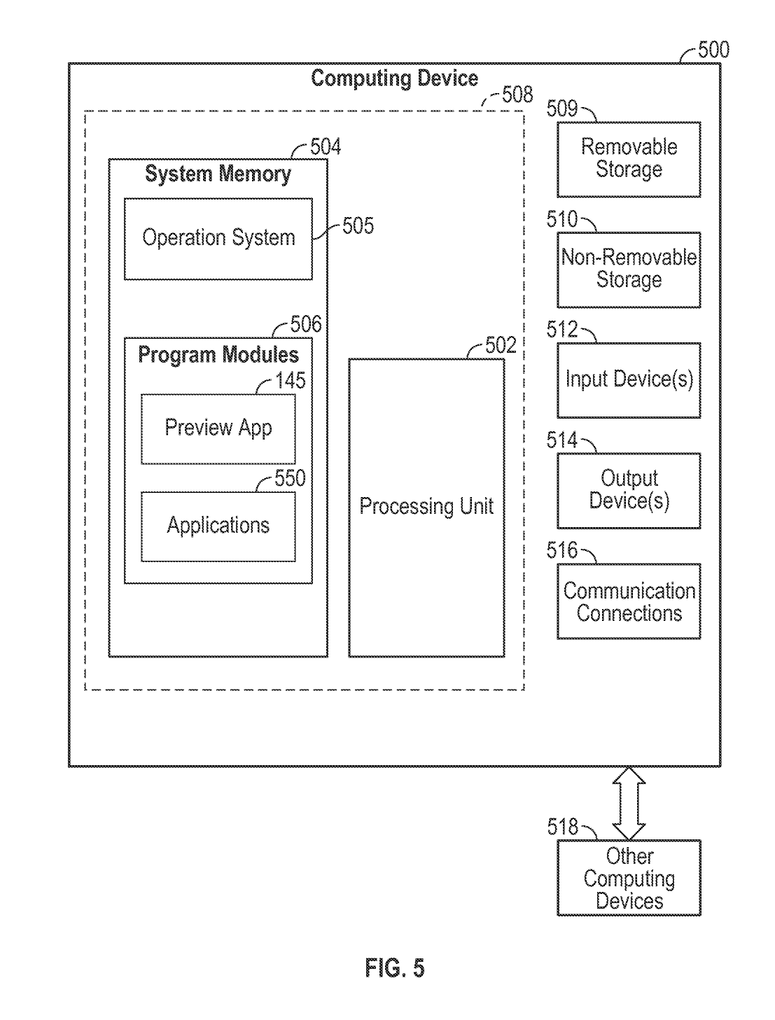

FIGS. 5-7 and the associated descriptions provide a discussion of a variety of operating environments in which embodiments of the invention may be practiced. However, the devices and systems illustrated and discussed with respect to FIGS. 5-7 are for purposes of example and illustration and are not limiting of a vast number of computing device configurations that may be utilized for practicing embodiments of the invention, described herein.

FIG. 5 is a block diagram illustrating physical components (i.e., hardware) of a computing device 500 with which embodiments of the invention may be practiced. The computing device components described below may be suitable for the client device 118 described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running software applications 550 such as the preview service 145 or one or more client applications, such as word processing applications, spreadsheet applications, slide presentation applications, and the like. The operating system 505, for example, may be suitable for controlling the operation of the computing device 500. Furthermore, embodiments of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including, but not limited to, one or more of the stages of the methods 300 and 400 illustrated in FIGS. 3 and 4. Other program modules that may be used in accordance with embodiments of the present invention and may include applications such as electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing an activity stream across multiple workloads may be operated via application-specific logic integrated with other components of the computing device 500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

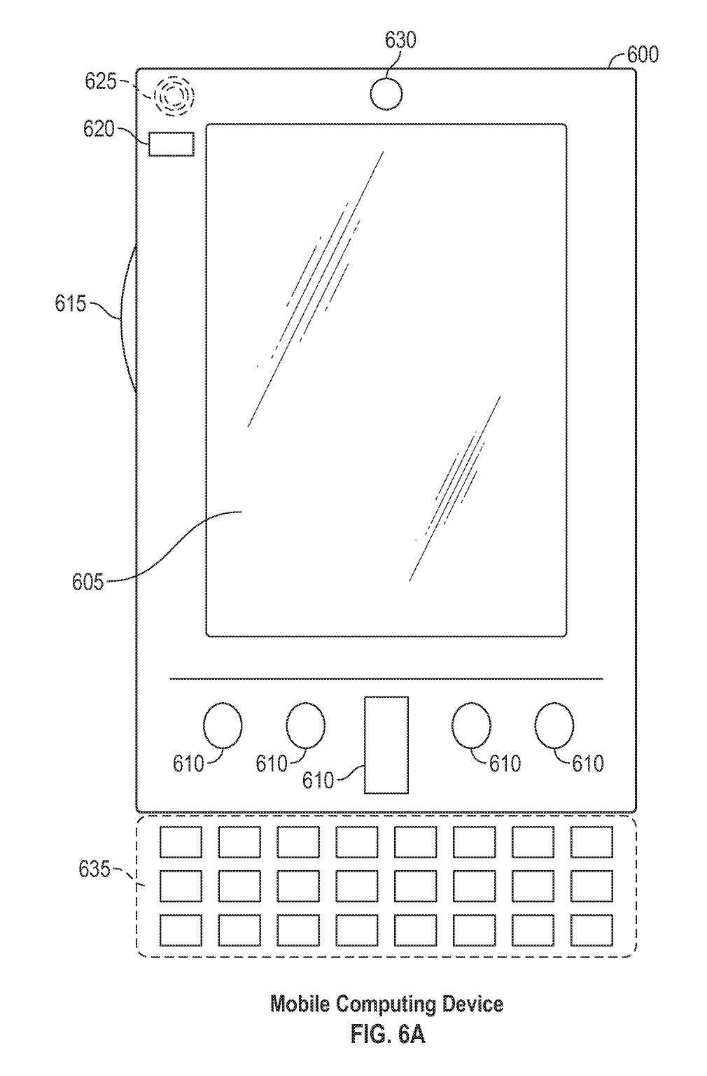

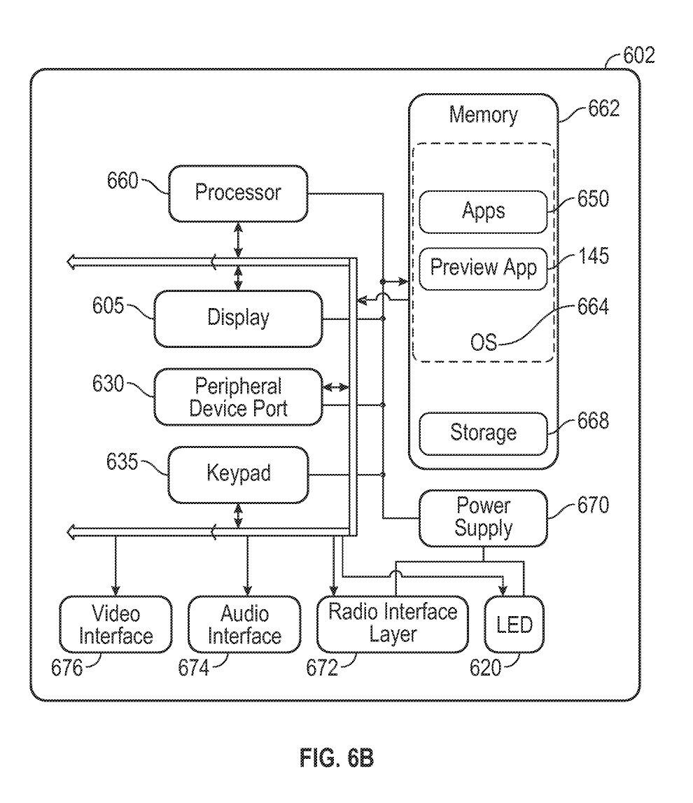

FIGS. 6A and 6B illustrate a mobile computing device 600, for example, a mobile telephone, a smart phone, a tablet personal computer, a laptop computer, and the like, with which embodiments of the invention may be practiced. With reference to FIG. 6A, one embodiment of a mobile computing device 600 for implementing the embodiments is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs 650 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 650, as well as the preview service 145, may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 150 via the operating system 664, and vice versa.

The visual indicator 620 may be used to provide visual notifications and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

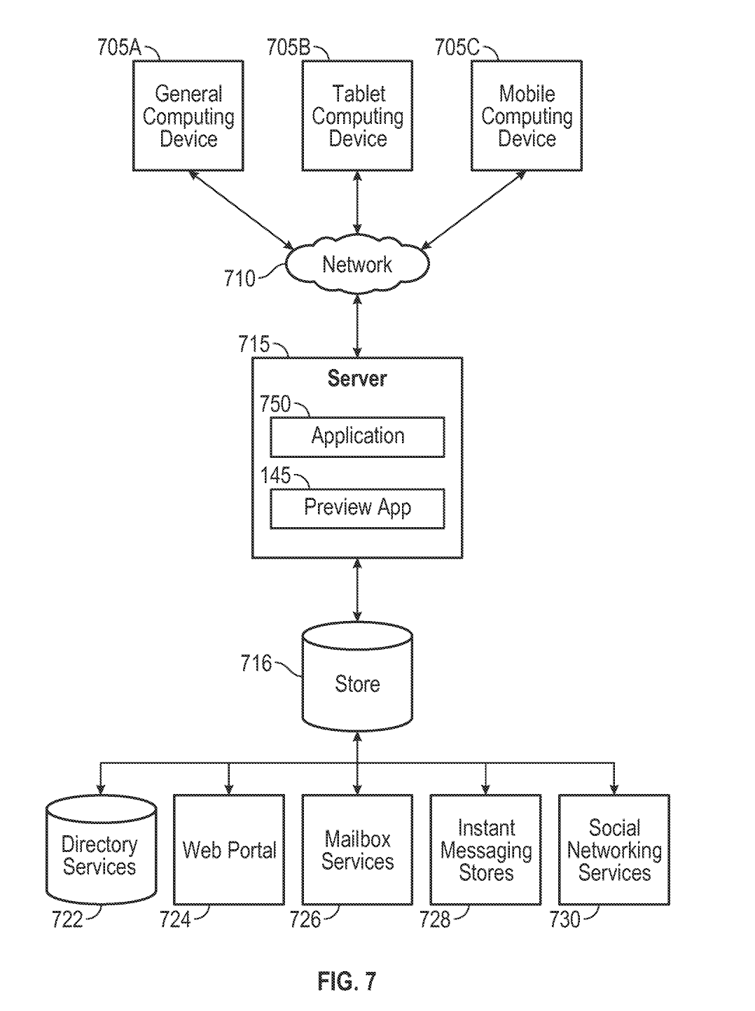

FIG. 7 illustrates one embodiment of the architecture of a system for providing an activity stream across multiple workloads, as described above. Content developed, interacted with, or edited in association with the preview service 145 may be stored in different communication channels or other storage types. For example, various documents may be stored using a directory service 722, a web portal 724, a mailbox service 726, an instant messaging store 728, or a social networking site 730. The shadowing systems 205, 255 may use any of these types of systems or the like for providing shadowed content, as described herein. A server 715 may provide the functionality of the application 145 to various clients. As one example, the server 715 may be a web server providing content over the web. The server 715 may provide the information from the application 145 over the web through a network 710. By way of example, the client computing devices illustrated and described with reference to FIG. 1 may be implemented and embodied in a personal computer 705A, a tablet computing device 705B and/or a mobile computing device 705C (e.g., a smart phone), or other computing device. Any of these embodiments of the client computing device may obtain content from the store 716 such as the store 150 described above.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method of generating a visual representation of a content item, comprising,
receiving a content item;
if a preview image is available for the content item, presenting the available preview image in a user interface as a visual representation of the content item; and
if a preview image is not available for the content item, dynamically generating one or more preview images for the content item, and presenting the dynamically generated one or more preview images in a user interface as a visual representation of the content item.

2. A method of claim 1, further comprising receiving a selection of the displayed preview image and allowing navigation to the content item.

3. The method of claim 1, wherein dynamically generating a preview image for the content item includes generating the preview image by one or more of:
generating a preview image from an image extracted from the content item;
generating the preview image from a plurality of images extracted from the content item;
generating the preview image from a screenshot of a portion of the content item;
generating the preview image from a plurality of screenshots of one or more portions of the content item;
generating the preview image with a background color and a portion of text extracted from the content item;
generating the preview image from an object extracted from the content item;
generating the preview image from text contained in the content item as a tag cloud where words with a large number of occurrences in the content item are rendered with larger fonts, but common words that occur in any content item may be ignored;
generating the preview image as a cropped version of an image that lives in the content item;
generating the preview image as a collage of a plurality of objects contained in the content item;
generating the preview image as a collage of screenshots of N pages, slides, or sheets contained in the content item;
generating the preview image as quote extracted from the content item;
generating the preview image as a tag cloud of the most used numbers in a spreadsheet document;
generating the preview image as a picture obtained from an external source that represents the most frequent terms in the content item; and
generating the preview image as an auto-generated table, chart, or other visual representation of one or more data items contained in the content item

4. The method of claim 1, prior to dynamically generating a preview image for the content item, identifying one or more components of the content item as preview image candidates that may be included in the dynamically generated preview image.

5. The method of claim 4, wherein dynamically generating the preview image includes generating the preview image from one or more of the one or more components of the content item identified as preview candidates.

6. The method of claim 5, prior to identifying one or more components of the content items as preview candidates, selecting a preview image source for obtaining one or more components of the content item as preview image candidates.

7. The method of claim 6, prior to selecting a preview image source, retrieving one or more sources for obtaining one or more preview image candidates for the content item.

8. The method of claim 7, prior to retrieving one or more sources for obtaining one or more preview image candidates, determining a file format for the content item for determining one or more sources that may be used for obtaining one or more preview image candidates.

9. The method of claim 4, further comprising ranking the preview image candidates according to one or more ranking variables.

10. The method of claim 9, further comprising weighting each of the one or more ranking variables so that a given ranking variable may be weighted more than another ranking variable in determining whether a given preview image candidate may be included in the generated preview image.

11. The method of claim 10, wherein a ranking model comprised of a given weighting of each of the one or more ranking variables is selected for application to each of the one or more ranking variables by one or more of:
a preview image service operative for generating the one or more preview images;
a client application for which the one or more preview images are generated; and
a user for which the one or more preview images are generated.

12. The method of claim 10, wherein the one or more ranking variables may include one or more of:
a resolution associated with each of the one or more preview image candidates;
a colorfulness associated with each of the one or more preview image candidates;
a position of each of the one or more preview image candidates in the content item;
a ratio of height versus width for each of the one or more preview image candidates;
a uniqueness of each of the one or more preview image candidates in the content item;
a number of people depicted in each of the one or more preview image candidates; and
a number of objects contained in each of the one or more preview image candidates.

13. The method of claim 9, further comprising selecting a highest ranked preview image candidate for inclusion in the generated preview image.

14. The method of claim 13, wherein, if a ranking for a given preview image candidate is less than a threshold ranking, rejecting the given ranked preview image candidate for inclusion in the generated preview image.

15. The method of claim 14, wherein, if no preview image candidate for the content item is ranked at or above the threshold ranking, providing an alternative preview image for the content item, and presenting the alternative preview image in a user interface as a visual representation of the content item.

16. A method of generating a visual representation of a search result, comprising,
receiving a search result content item;
identifying one or more components of the content item as preview image candidates that may be included in a generated preview image;
ranking the preview image candidates according to one or more ranking variables;
selecting a highest ranked preview image candidate;
generating the preview image for the content item from the highest ranked preview image candidate; and
presenting the generated preview image in a user interface as a visual representation of the content item.

17. The method of claim 16, further comprising weighting each of the one or more ranking variables so that a given ranking variable may be weighted more than another ranking variable in determining whether a given preview image candidate may be included in the generated preview image.

18. The method of claim 16, wherein generating the preview image for the content item from the highest ranked preview image candidate includes generating the preview image by one or more of:
generating a preview image from an image extracted from the content item;
generating the preview image from a plurality of images extracted from the content item;
generating the preview image from a screenshot of a portion of the content item;
generating the preview image from a plurality of screenshots of one or more portions of the content item;
generating the preview image with a background color and a portion of text extracted from the content item;
generating the preview image from an object extracted from the content item;
generating the preview image from text contained in the content item as a tag cloud where words with a large number of occurrences in the content item are rendered with larger fonts, but common words that occur in any content item may be ignored;
generating the preview image as a cropped version of an image that lives in the content item;
generating the preview image as a collage of a plurality of objects contained in the content item;
generating the preview image as a collage of screenshots of N pages, slides, or sheets contained in the content item;
generating the preview image as quote extracted from the content item;
generating the preview image as a tag cloud of the most used numbers in a spreadsheet document;
generating the preview image as a picture obtained from an external source that represents the most frequent terms in the content item; and
generating the preview image as an auto-generated table, chart, or other visual representation of one or more data items contained in the content item

19. The method of claim 16, prior to identifying one or more components of the content item as preview image candidates that may be included in a generated preview image, further comprising:
determining a file format for the content item for identifying one or more preview image sources that may be used for identifying one or more components of the content item as preview image candidates; and
selecting a preview image source for identifying one or more components of the content item as preview image candidates;

20. A system for generating a visual representation of a search result, comprising:
one or more processors; and
a memory coupled to the one or more processors, the one or more processors operable to:
receive a search result content item;
select a preview image source for identifying and obtaining one or more components of the content item as preview image candidates that may be included in a preview image for the content item;
rank the preview image candidates according to one or more ranking variables;
weight each of the one or more ranking variables so that a given ranking variable may be weighted more than another ranking variable in determining whether a given preview image candidate may be included in the generated preview image;
select a highest ranked preview image candidate for inclusion in the generated preview image;
generate a preview image for the content item using the selected highest ranked preview image candidate for the preview image; and
present the generated preview image in a user interface as a visual representation of the content item.
